(19) United States
(12) Patent Application Publication
(10) Pub. No.: US 2005/0025860 A1
(43) Pub. Date: Feb. 3, 2005

(54) Seasoning liquid

(75) Inventor: Shigeru Hatakenaka, Kami (JP)

Correspondence Address: KODA & ANDROLIA, 2029 CENTURY PARK EAST, SUITE 1430, LOS ANGELES, CA, 90067-3024, US

(73) Assignee: Hatakenaka Shoyu Jyouzoujyou, Ltd.

(21) Appl. No.: 10/927,409

(22) Filed: Aug. 26, 2004

Related U.S. Application Data
(62) Division of application No. 09/618,306, filed on Jul. 18, 2000.

(51) Int. Cl. C12J 1/00

(52) U.S. Cl. 426/17

(57) ABSTRACT

There are disclosed vinegar produced by a brewing method in which in a water absorption process or steaming process of cereals such as rice, wheat, corn for rice vinegar or cereal vinegar, cereals is treated with sea water and these treated cereals is applied to a given brewing method to produce the vinegar, and vinegar obtained by using sea water instead of clean natural water as adding water or together with clean natural water as adding water in the production process, and seasoning vinegar such as Awasezu (blended vinegar), Ajitsuke-ponzu (seasoning liquid that blended soy sauce and vinegar with fruit juice of bitter orange), Tare of Tataki (relish paste for lightly roasted bonito or beef), seasoning vinegar for fishery processing is improved and seasoning liquid using this vinegar is improved, by prepared by mixing this vinegar, and any one of sea water, concentrated sea water and de-salted sea water, and one or more of a salty agent, a sweetener, a sour agent, a bitter agent, a tasting agent and an oil agent.

### BACKGROUND OF THE INVENTION

1. Field of the Invention

The present invention relates to vinegar using sea water (surface layer sea water, deep layer sea water, concentrated sea water, de-salted sea water) and seasonings thereof.

2. Prior Art

Vinegar is broadly classified into synthetic vinegar and brewed vinegar. The synthetic vinegar is produced by diluting synthesized acetic acid with water and compounding seasonings, sweetener, coloring agents and the like into the diluted acetic acid. The brewed vinegar is classified into rice vinegar, fruit vinegar, alcohol vinegar and the like based on raw materials. Any of them is produced by acetic acid fermentation in which acetic acid is produced from alcohol using acetic acid bacteria (ex.Acetobacter aceti).

Also, vinegar can be mixed with other seasonings, water, alcohol and the like to give seasoning liquid, for example, Sushizu (Awasezu=blended vinegar for Sushi), dressing, mixed liquid for pickles, Ajitsuke-ponzu (seasoning liquid that blended soy sauce and vinegar with fruit juice of bitter orange), tare (relish paste), sauce, ketchup, vinegar bean-paste, beverage (black vinegar drink, apple vinegar drink), fishery processed liquid, Tsuyu (relish liquid), sweet vinegar, vinegar for dishes in sweetened vinegar and the like.

Both vinegar and seasoning liquids mixing vinegar have long been produced and used for dish. The method for producing vinegar is basically based on old production methods. For example, usually in the stationary fermentation of vinegar, a common point in all stationary fermentation is that a fermentation period of 2 weeks to 2 months is required though influenced somewhat by the form of a fermentation vessel, nature of fungus, amount of seed fungus, temperature of the outer atmosphere, amount of liquid, and the like, and it is generally supposed that there is no room in the production method for such a revolutionary improvement as to significantly influence taste.

Likewise in a production method of seasoning liquid using vinegar, though certain investigation and improvement are made for enhancing the taste of seasoning liquid, the production method thereof is not different significantly from conventional methods.

Conventionally, in production of rice vinegar, Saka-mai (special rice in Japonica rice for brewing Japanese Sake) having high water absorption is used as a raw rice material. When other kind of rice (for example Indica rice) having low water absorption is used, there is a problem of a long time and trouble for absorption of water. Further, Saka-mai and Indica rice have a significant difference also in the taste of vinegar obtained, and mild flavor produced by Saka-mai can not easily be realized by Indica rice. Therefore, use of Indica rice as a raw rice material of rice vinegar has been avoided until now.

### SUMMARY OF THE INVENTION

Since Indica rice is cheap as compared with Saka-mai, if vinegar having flavor comparable with that obtained by using Saka-mai as a raw material can be produced by using Indica rice as a raw material, it would be possible to provide vinegar having excellent flavor with a cheap material. Moreover, if the water absorption of a raw material can be improved, the utilization factor of a raw material increases. Namely, by improving the water absorption of a cereal raw material, it becomes possible to enhance saccharification and fermentation and to obtain alcohol in a great amount from a certain amount of raw material and it becomes possible to produce vinegar in a great amount from the obtained alcohol.

Then, the inventor have made various investigations of improvements in the taste, moisture retaining property, evaporation property (volatilization property), freshness retaining property, storability and the like of food seasoned by using vinegar and seasoning using vinegar.

As a result of the investigation of the above-mentioned object, in a water absorption process or steaming process of cereals such as rice, wheat, corn and the like for rice vinegar or cereal vinegar in a procedure for producing vinegar, cereals are treated with sea water and these materials treated with sea water is applied to a given brewing method to produce vinegar. Further, sea water instead of clean natural water which is adding water, or sea water together with clean natural water which is adding water is used in a production process to provide vinegar.

The sea water referred to in the present invention is a generic term including surface layer sea water, and is not limited to deep layer sea water. This term is also referred to concentrated sea water or de-salted sea water depending on use object. Though there is no strict definition regarding the surface layer and deep layer of surface layer sea water and deep layer sea water, a region wherein a solar beam can not reach and photosynthesis is not conducted and which is deeper than sea surface usually by 200 m or more is usually called deep layer. Therefore, sea water collected at a region below the sea surface by 200 m or more is called deep layer sea water, and sea water collected at a shallower region is called surface layer sea water. Sea water which has been collected and has not received any treatment is called raw sea water.

Concentrated sea water is sea water in which the concentrations of various components contained are increased by removing water from raw sea water. The water removal means may be heating vaporization or distillation, or may be a known means using reverse osmosis film or other separation film (hollow yarn films or the like).

De-salted water is sea water in which the salt concentration is reduced as low as possible around usually from 10⁻¹ to 10⁻³%, for example, NaCl=0.00863% (electric conductivity 241 μs/cm), and can be subjected to de-salted by using a separation film such as an ion exchange film, reverse osmosis film, hallow yarn film or the like. The concentrated sea water has excellent storability since the salt content can be concentrated to near that of saturated saline, and has a merit in that the volume in use for treatment may be low. Raw sea water, concentration sea water or de-salted sea water collected from any one of surface layer and deep layer can be used.

Adding water using raw sea water, concentration sea water and de-salted sea water is “Shikomi-sui (adjustment water of concentration)” when vinegar is produced by brewing. Further, when vinegar is produced from synthetic acetic acid (synthetic vinegar), the adding water is called “Kishaku-sui (diluting water).” In the present invention, de-salted sea water containing almost no salt is used, depending on the objective. Also in this case, to reinforce mineral or supplement components deficient only in de-salted sea water, raw sea water or concentrated sea water is partially added, the above case also being included in the present invention.

When vinegar is produced by brewing, if raw sea water, concentrated sea water or de-salted sea water is used as adding water, the brewing period can be shortened. When the brewing period is shortened, the brewing cycle can be increased to improved the production efficiency. In addition, the number of germ mixed in the brewing period decreases, and the possibility that components other than acetic acid are contained is lower. Accordingly, vinegar having almost no peculiar taste and having excellent flavor can be obtained.

Also in the case of synthetic vinegar produced from synthetic acetic acid, if raw sea water, concentrated sea water or de-salted sea water is used as adding water, taste is improved, stimulus to tongue specific to synthetic vinegar decreases to obtain mild feeling. In addition, by delay of evaporation of water in the brewed vinegar, freshness is retained, whereas, by delay of evaporation of an acid, corrosion delays, bactericidal action is obtained, and flavor is kept.

In addition to the above-mentioned matters, in the present invention, seasoning liquid has been developed prepared by blending vinegar, and any one of raw sea water, concentrated sea water and de-salted sea water, and one or more of a salty agent, a sweetener, sour agent, bitter agent, tasting agent and oil agent. Examples of the seasoning liquid include Sushizu (Awasezu=blended vinegar for Sushi), dressing, mixed liquid for pickles, Ajitsuke-ponzu (seasoning liquid that blended soy sauce and vinegar with fruit juice of bitter orange), tare (relish paste), sauce, ketchup, vinegar bean-paste, beverage (black vinegar drink, apple vinegar drink), fishery processed liquid, Tsuyu (relish liquid), sweet vinegar, vinegar for dish in sweetened vinegar and the like. These seasoning liquids get improved flavor and mild taste by use of any of raw sea water, concentrated sea water and de-salted sea water. Further, by delay of the evaporation of a sour flavor, corrosion delays and flavor lasts long.

### BRIEF DESCRIPTION OF THE DRAWINGS

FIG. 1 is a flow chart of sake-lees vinegar using sea water;

FIG. 2 is a flow chart of other example sake-lees vinegar using sea water;

FIG. 3 is a graph showing the relation of the number of elapsed days during brewing and the degree of acidity for each kind of Shikomi-sui;

FIG. 4 is a graph showing the relation of the number of elapsed days during brewing and the degree of acidity for each kind of Shikomi-sui to which raw sea water has been added;

FIG. 5 is a flow chart of an example using sea water when rice vinegar is produced by fermentation;

FIG. 6 is a graph showing the water content at each time in soaking, steaming and introduction;

FIG. 7 is a graph showing the water absorption at each time in soaking, steaming and introduction;

FIG. 8 is a flow chart of fruit vinegar using sea water;

FIG. 9 is a flow chart of an example for producing fruit vinegar using sea water via fruit wine;

FIG. 10 is a flow chart of an example using sea water in the production of rice vinegar by a jar fermentation method;

FIG. 11 is a flow chart of an example using sea water in the production of synthetic vinegar;

FIG. 12 is a graph showing the change with the lapse of days of the acidity of combined vinegar using vinegar of high acidity depending on the difference of diluting water;

FIG. 13 is a graph showing the change with the lapse of days of the acidity of combined vinegar using vinegar of high acidity depending on the difference of diluting water;

FIG. 14 is a graph showing the change with the lapse of days of the acidity of combined vinegar using synthetic acetic acid depending on the difference of diluting water; and

FIG. 15 is a graph showing the decreasing tendency of vinegar when the Tare of Tataki (relish paste for lightly roasted bonito or beef) is packed in LDPE/AL/LDPE polyester packs.

### DETAILED DESCRIPTION OF THE PREFERRED EMBODIMENTS

Production of Brewed Vinegar (Sake-lees Vinegar)

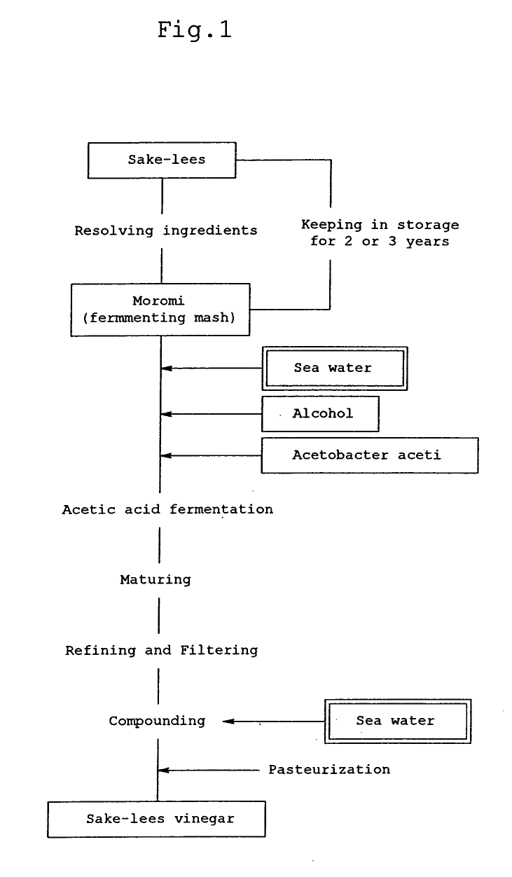

The method for producing Sake-lees vinegar using sea water is as shown in the flow chart of FIG. 1.

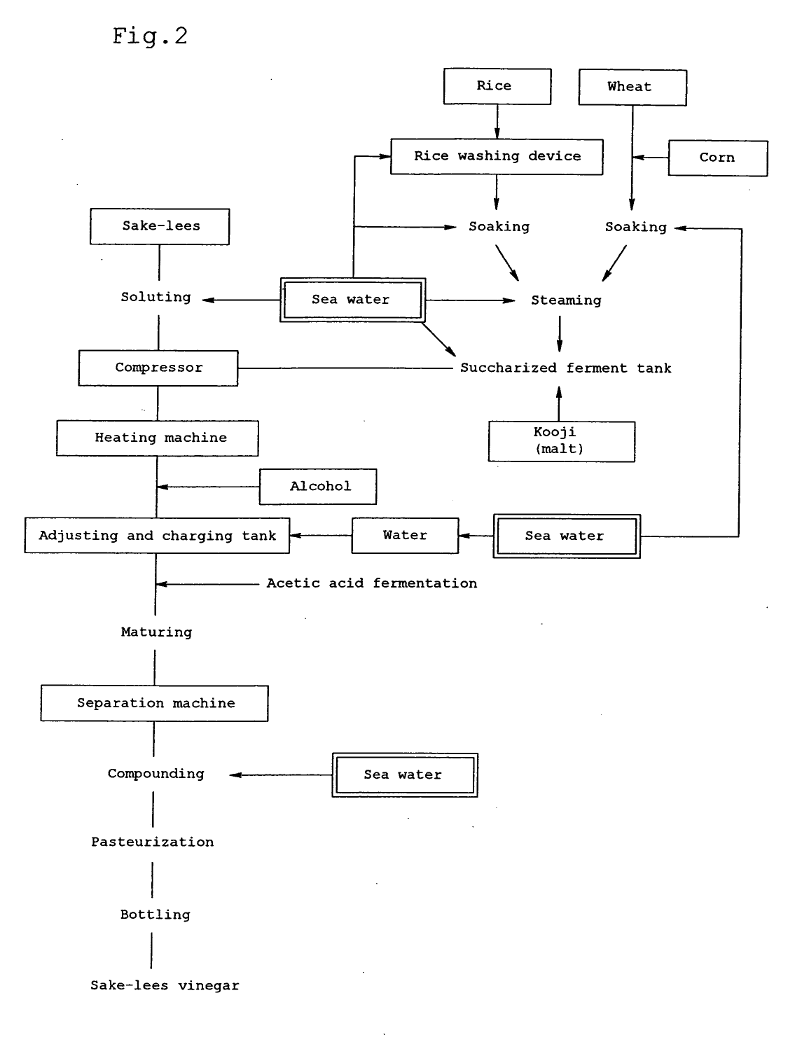

The method for producing Sake-lees vinegar using sea water according to another example is shown in the flow chart of FIG. 2.

Shikomi-sui was prepared as follows.

### EXAMPLE 1

In the Case of Using Surface Layer Sea Water

The salt concentration was adjusted to the same salt concentration (NaCl=0.00863%) of de-salted deep layer sea water, for enabling comparison. For this purpose, tap water was added to 78.2 ml of sea water to obtain a total amount of 29 liter.

### EXAMPLE 2

In the Case of Using Deep Layer Sea Water

In this example, for the same reason for Example 1, tap water was added to 59.45 ml of concentrated sea water (salt content 4.2%) to obtain a total amount of 29 liter.

### EXAMPLE 3

In the Case of Using De-salted Deep Layer Sea Water

29 liter of de-salted sea water (salt concentration NaCl=0.00863%, commercially available) was used.

### COMPARATIVE EXAMPLE 1

In the Case of Using Tap Water

29 liter of tap water was used.

Tap water left for 24 hours for extraction of minerals was used.

The raw materials in Examples 1 to 3 and Comparative Example 1 are obtained by adding the common raw material described below to 29 liter of the charging water describe above.

| | | |
|---|---|---|
| Raw material Moromi (= fermentation mash, | 0.2 | kg |
| in case of sake-lees): | | |
| Seed vinegar (degree of acidity - 5%): | 16.3 | liter |
| Denatured-alcohol (degree of acidity - 5%, and | 3.7 | liter |
| alcohol - 47.5%): | | |

Adjusting and Charging Method

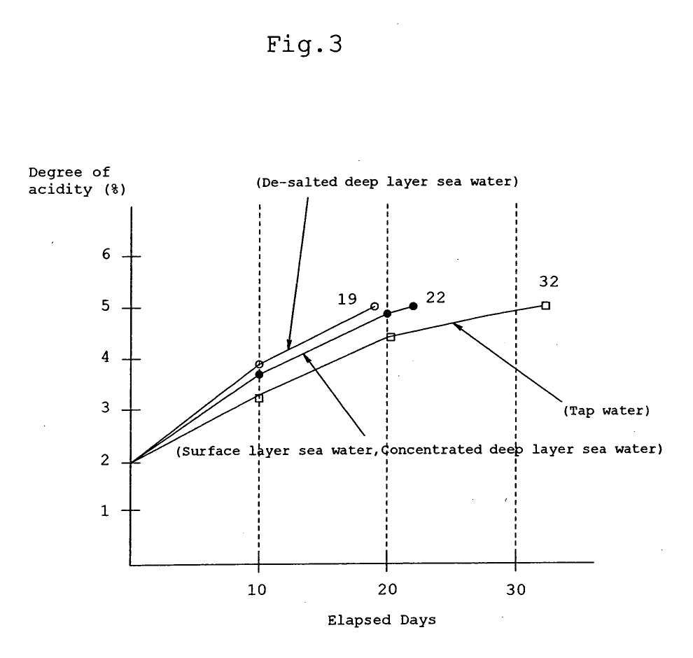

The above-described raw material Moromi, sake-lees and, denatured-alcohol and Shikomi-sui were mixed and heated, the mixture was placed in a stainless fermentation tank and mixed completely with seed vinegar. The heating was so controlled that the temperature was from 30 to 34° C. in mixing with seed vinegar. The liquid was sampled during fermentation once per three days taking care so that the liquid temperature did not exceed 38° C., and the degree of acidity thereof was measured. When the degree of acidity reached 5%, the fermentation was terminated. FIG. 3 shows the relation of the number of elapsed days during brewing and the degree of acidity for each kind of Shikomi-sui. In the case of charging of de-salted sea water, the process is fastest and the brewing is completed in 19 days. In the cases of charging of sea water and concentrated sea water, the brewing is completed in 22 days. In the case of charging of tap water, 32 days are required. From these results, it becomes apparent that when sea water, concentrated sea water or de-salted sea water is used as charging water, the brewing of acetic acid is accelerated efficiently. Further, when sea water, concentrated sea water or de-salted sea water is used as charging water, vinegar having good taste and excellent in flavor is obtained.

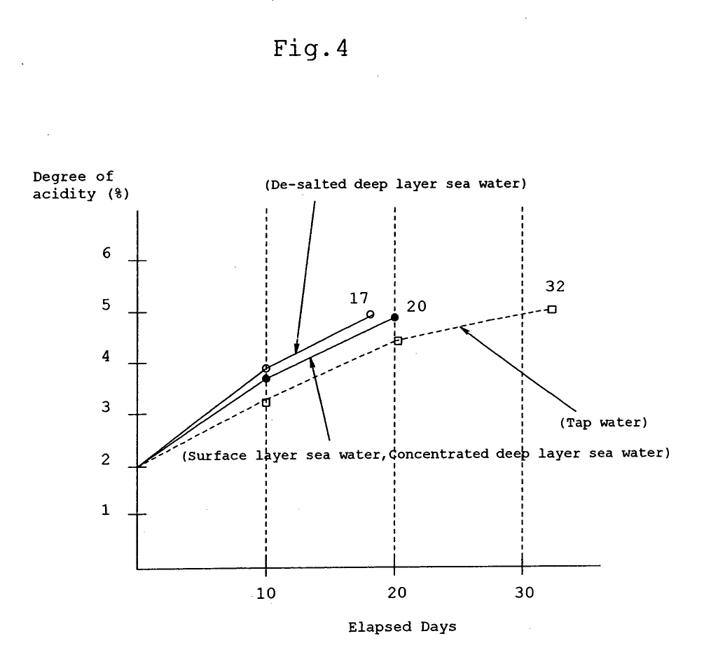

FIG. 4 shows the relation of the number of fermentation days and the degree of acidity when 5% of raw water is added to the example of FIG. 3 to increase the amount of minerals. This shows accelerated fermentation.

De-salting of sea water has a problem that minerals in sea water are removed simultaneously. Therefore, a small amount (5%) of raw sea water was added to de-salted sea water in charging of the above-described de-salted sea water and the resulted mixture was used in the test. The result is shown in FIG. 4. In the case of de-salted sea water, the brewing is completed in 17 days, and in the case of concentrated sea water, the brewing is completed in 20 days. From these results, it becomes apparent that when a small amount (5%) of raw sea water is added to the charging water for sea water, concentrated sea water and de-salted sea water, the brewing of acetic acid is further accelerate by mineral making-up effect. The resulted vinegar has mild and fresh taste without peculiar taste. It is hypothesized that this is ascribed to decrease in generation of germ due to reduction of the brewing period.

Table 1 shows results of analysis of components of brewed vinegar when a small amount (5%) of raw sea water is used in preparation of the above-mentioned de-salted sea water. Comparative example 1 is the case of tap water as Shikomi-sui without adding raw sea water. It is known that in the case of charging of de-salted deep layer sea water, the amount of reduced saccharide is low and fermentation is flouring. In the case of charging of de-salted sea water, the amount of amino-type nitrogen, by product in fermentation is low, and fresh taste with almost no peculiar taste is obtained.

TABLE 1

| | | Non- | | | | Amino- | |
|---|---|---|---|---|---|---|---|
| | | volatil- | | Reduc- | | type | |
| | Total | ized | | ing | Nitro- | nitro- | Ex- |
| | acid | acid | Sugar | sugar | gen | gen | tract |
| In case of | 5.00 | 0.18 | 1.30 | 0.20 | 0.02 | 0.008 | 1.70 |
| using | | | | | | | |
| tap water | | | | | | | |
| In case | 5.00 | 0.17 | 1.29 | 0.17 | 0.02 | 0.005 | 1.70 |
| of using | | | | | | | |
| de-salted | | | | | | | |
| deep layer | | | | | | | |
| sea water | | | | | | | |
| | | | | | | | (g/100 |
| | | | | | | | ml) |

Production of Brewed Vinegar (Rice Vinegar)

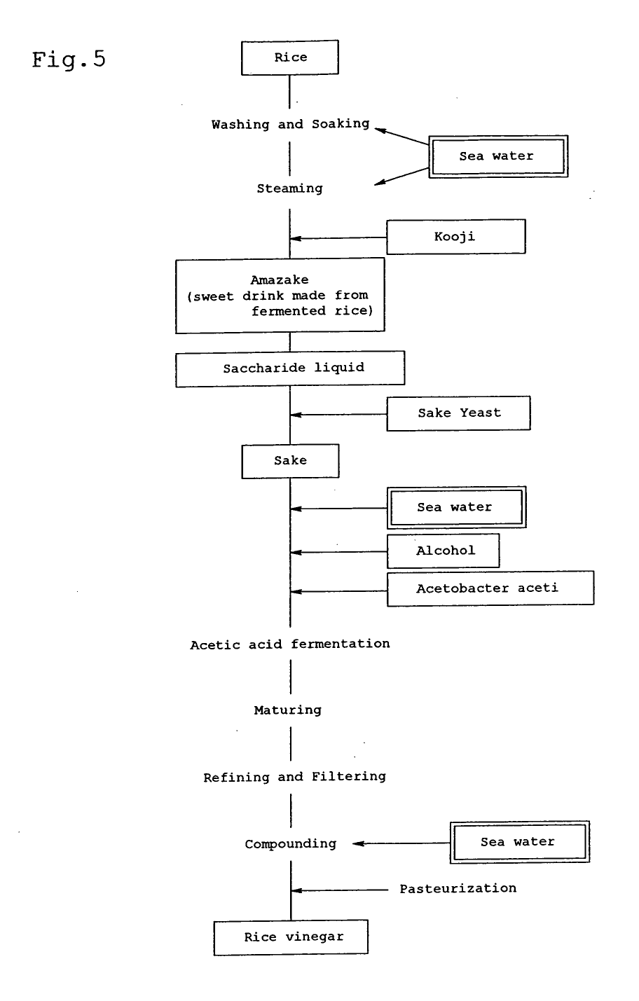

In the production of rice vinegar, after production of sake (refined sake), alcohol is fermented to obtain vinegar, as shown in the flow chart of FIG. 5. In the present invention, also in processes until sake, sea water (de-salted surface layer sea water, de-salted deep layer sea water) can be used in immersing raw material rice and the preparation of Moromi.

### EXAMPLE 4

(a) Tap water (Comparative Example 1) and de-salted sea water were used as soaking water before steaming of rice. To the de-salted sea water was added 5% raw sea water. Saka-mai (water content 13.6%) and Indica rice (water content 13.3%) were used as raw material rice, each at a cleaning degree of 70%. The sample was immersed at 12 to 20° C. for 16 hours. The water absorption of rice after the immersing is shown in Table 2.

TABLE 2

| | Saka-mai | Indica rice |
|---|---|---|
| Soaking in | 28.4 | 23.1 |
| tap water | | |
| Soaking in | 29.4 | 24.4 |
| de-salted surface | | |
| layer sea water | | |
| Soaking in | 31.1 | 25.9 |
| de-salted deep | | |
| layer sea water | | |
| | | (wt %) |

Table 2 demonstrates the following matters.

(1) Indica rice has lower water absorption as compared with Saka-mai.

(2) Soaking in de-salted sea water provides more excellent water absorption than soaking in tap water.

(3) Though the water absorption is conventionally approximately the same providing the degree of rice polishing is the same, by addition of soaking water, water absorption varies and the water absorption in the case of soaking in de-salted sea water increases by 4.4 to 6.5% in the case of Saka-mai and 1.5 to 2.9% in the case of Indica rice, as compared with the case of immersing into tap water.

(b) Water removal by dropping is conducted after soaking, and washing with flowing water is conducted for 10 minutes. Then, the change in mineral components in rice after soaking is measured. The results are shown in Table 3.

TABLE 3

| | | De-salted | De-salted |
|---|---|---|---|
| | tap | surface layer | deep layer |
| | water | sea water | sea water |
| K | 182 | 212 | 214 |
| Mg | 28 | 35 | 36 |
| Ca | 72 | 77 | 78 |
| | | | (PPM) |

Table 3 demonstrates the following matters.

(1) In the case of soaking in de-salted sea water (containing 5% sea water), K, Mg and Ca are contained in higher amount than in the case of soaking in tap water.

(2) In the case of soaking in de-salted sea water (containing 5% sea water), K, Mg and Ca are contained in higher amount than in the case of tap water, and by soaking, the K, Mg and Ca components in the de-salted sea water transferred to rice, therefore the amount of K, Mg and Ca is higher than in the case of soaking in tap water.

(3) Usually, water is removed by dropping overnight. When the temperature of the outer atmosphere reaches 20° C. or more, steamed rice may become red by the propagation of bacteria, but in the case of soaking in de-salted sea water, the propagation of bacteria is suppressed, and the rice does not easily turn to red.

(c) Next, steaming is conducted by the following method. The water content of the steamed rice directly after the steaming is measured. Table 4 shows examples of Saka-mai, and Table 5 shows respective water absorption of respective Indica rice.

TABLE 4

| | | De-salted surface | De-salted deep |
|---|---|---|---|
| | | layer sea water | layer sea water |
| | | vapor | vapor |
| | Tap water vapor | Steamed rice water | Steamed rice water |
| | Steamed rice | absorption | absorption |
| | water absorption | De-salted surface | De-salted deep |
| | Tap water | layer sea water | layer sea water |
| Soaking in | 36.9 | — | — |
| tap water | | | |
| Soaking in | — | 38.4 | — |
| de-salted | | | |
| surface | | | |
| layer sea | | | |
| water | | | |
| Soaking in | — | — | 41.6 |
| de-salted | | | |
| deep layer | | | |
| sea water | | | |
| | | | (wt %) |
| | | | (to next page) |

TABLE 5

| | | De-salted surface | De-salted deep |
|---|---|---|---|
| | | layer sea water | layer sea water |
| | | vapor | vapor |
| | Tap water vapor | Steamed rice water | Steamed rice water |
| | Steamed rice | absorption | absorption |
| | water absorption | De-salted surface | De-salted deep |
| | Tap water | layer sea water | layer sea water |
| Soaking in | 28.9 | — | — |
| tap water | | | |
| Soaking in | — | 30.9 | — |
| de-salted | | | |
| surface | | | |
| layer sea | | | |
| water | | | |
| Soaking in | — | — | 34.2 |
| de-salted | | | |
| deep layer | | | |
| sea water | | | |
| | | | (wt %) |

The following matters are apparent from Table 4 and Table 5.

(1) Both in the cases of Saka-mai and Indica rice, the water absorption increases more significantly by steaming with a de-salted sea water vapor than with a tap water vapor. Among de-salted sea water vapors, a deep layer sea water vapor provides the most excellent result.

(2) Both tap water and de-salted sea water are softened in an ion exchange apparatus before use, and the hardness is near zero.

(3) The absorption of Indica rice can attain approximately the same value as the water absorption as established by conventional treatment of Saka-mai, by soaking in and steaming with de-salted sea water.

(d) Introduction into Kooji Room

The water absorption of steamed rice directly after steaming is from 35 to 40% in the case of Saka-mai and from 30 to 35% in the case of Indica rice. The results of measurement of the water absorption in introducing steamed rice after cooling to room temperature are shown in Table 6. Using these results, the water absorption in introducing is calculated and results thereof are shown in Table 7.

TABLE 6

| | Saka-mai | Indica rice |
|---|---|---|
| Soaking and | 29.2 | 24.0 |
| Steaming with | | |
| tap water | | |
| Soaking and | 31.5 | 26.7 |
| Steaming with | | |
| de-salted | | |
| surface layer | | |
| sea water | | |
| Soaking and | 33.2 | 28.7 |
| Steaming with | | |
| de-salted deep | | |
| layer sea water | | |
| | | (wt %) |

TABLE 7

| | Saka-mai | Indica rice |
|---|---|---|
| Soaking and | 22.0 | 14.1 |
| Steaming with | | |
| tap water | | |
| Soaking and | 26.2 | 18.3 |
| Steaming with | | |
| de-salted | | |
| surface layer | | |
| sea water | | |
| Soaking and | 29.5 | 21.6 |
| Steaming with | | |
| de-salted deep | | |
| layer sea water | | |
| | | (wt %) |

The following matters are apparent from Table 6 and Table 7.

(1) Soaking and steaming in de-salted sea water, water is not easily evaporated as compared in the case of soaking in and steaming with tap water. That is, a moisture retaining property is obtained and aging is delayed.

(2) When Indica rice is soaking in and steamed with de-salted sea water, water absorption and water-retaining property are improved, and that containing water in an amount near that in the case of conventional Saka-mai treatment using tap water or clean natural water. Resultantly, Indica rice can be used in sake production without special processing.

(3) In comparison in functionality, soaking in and steaming with in de-salted sea water gives expansion of steamed rice. By treatment with de-salted water, the whole water content is increased, whereas the surface water content of steamed rice is low to the contrary. The surface of steamed rice is not sticky, revealing easily separating property. Treatment with sea water provide excellent water absorption, enhances water-retaining property, and gives delay in aging.

Test of Evaporation of Water of Steamed Rice

Steamed rice after steaming is placed into a sealed vessel, stored at 5° C. for 24 hours, then, the change in water content is measured and results are shown in Table 8.

TABLE 8

| | Soaking and | |
|---|---|---|
| | Steaming Saka-mai | Soaking and |
| | with de-salted deep | Steaming Saka-mai |
| | layer sea water | with tap water |
| The amount of | 55.0 | 51.2 |
| water content | | |
| directly after | | |
| steaming | | |
| The amount of | 54.6 | 49.1 |
| water content | | |
| after strage in | | |
| frozen | | |
| condition for | | |
| 24 hours | | |
| The amount of | 1.6 | 8.2 |
| water | | |
| evaporation | | |
| | | (wt %) |

The amount of water evaporation after storage in frozen condition for 24 hours is significantly smaller in the case of treatment with de-salted sea water. From this result, it is expected that also the water content of steamed rice in a Seigiku room (the room cultivate Kooji) is advantageous in the case of use of de-salted sea water.

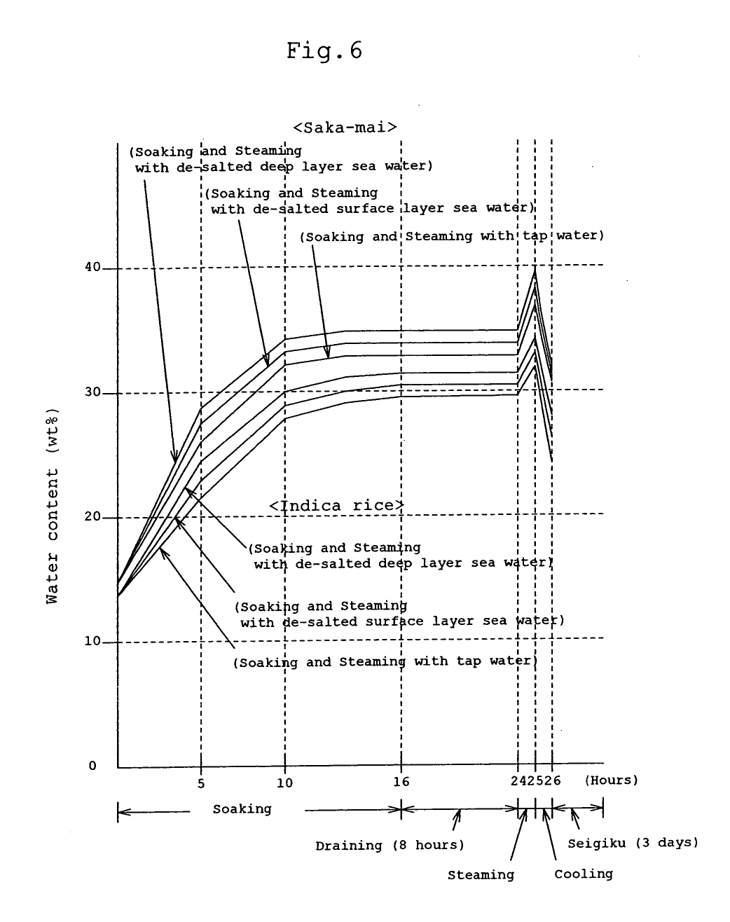

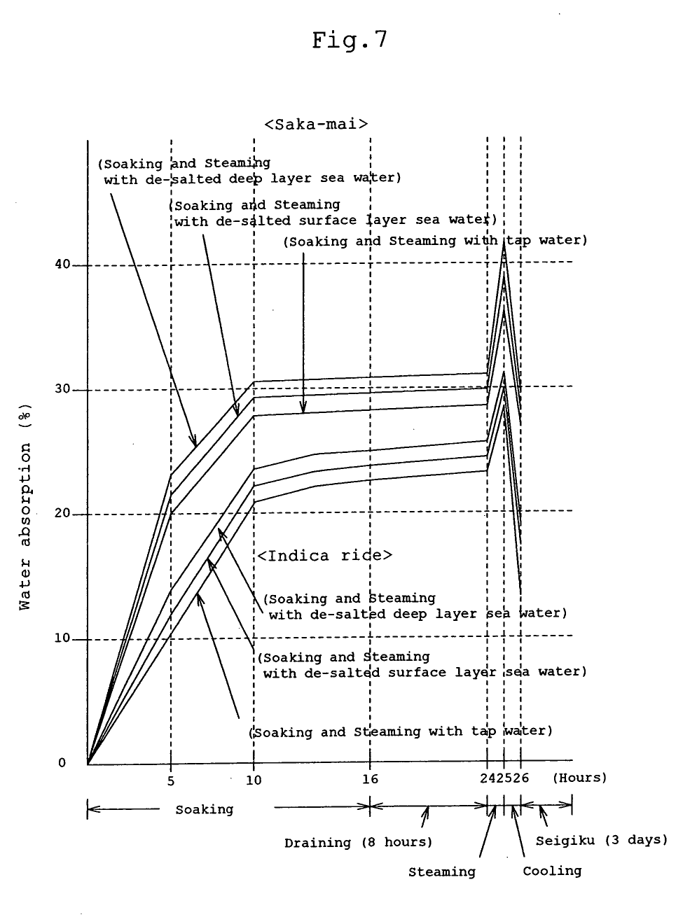

A graph of water contents at respective points of soaking, steaming and introduction as described above is shown in FIG. 6. Further, moisture content derived from this are shown in FIG. 7. Moisture content is greatest in the case of the use of de-salted deep layer sea water, followed by the use of de-salted surface layer sea water, and water absorption is poorest in the case of the use of tap water.

When steamed rice is cooled and left, it is cured and the digestion with an enzyme becomes difficult. This is called aging, and the degree of aging is also conducted. The degree of paste forming (α degree) of steamed rice is measured, and the change thereof with the lapse of time is represented as the degree of aging. Aged steamed rice reveals hard and fragile condition. The degree of aging is represented by the following formula.
Degree of aging %=100%·(degree of paste forming 24 hours after steaming/degree of paste forming directly after steaming)×100

As a result of measurement of the degree of aging by a β-amylase planase method (BAP method), when Saka-mai is treated with de-salted deep layer sea water, the degree of aging is 2.6, and when treated with tap water, 4.8. It becomes apparent that in treatment with de-salted deep layer sea water, the degree of aging is lower, and digestion with oxygen tends to occur.

Steamed rice treated with the above-mentioned treatments is placed in a simple mechanical Kooji production apparatus for 3 days under regulated aeration according to a normal method, to provide.

The produced Kooji after culturing are compared in quality by functionality. The results are as shown below.

(1) In both cases of molted rice of Saka-mai Kooji and Indica rice Kooji, the Kooji is soft and manifests good separation without stickiness in use of de-salted sea water

(2) A Kooji treated with de-salted sea water become a Sohhaze-Kooji, and hypha of Kooji is fully filled breaking the inner side of steamed rice (Sohhaze-Kooji=hypha of Kooji is fully filled breaking the inner side of rice).

The reason for this is hypothesized that steamed rice treated with de-salted sea water has lower surface water content even if the water absorption is higher, and the steamed rice is expanded and reveals excellent separability, leading to a good Kooji.

The enzymatic potency of the produced Kooji is measured and the results are shown in Table 9.

TABLE 9

| | | | | Acid |
|---|---|---|---|---|
| | | Gluco- | Acid- | carboxy- |
| | α-amylase | amylase | protease | peptidase |
| Soaking and | 950 | 220 | 3,600 | 5,900 |
| Steaming | | | | |
| Saka-mai | | | | |
| with tap | | | | |
| water | | | | |
| Soaking and | 1,100 | 215 | 3,900 | 6,200 |
| Steaming | | | | |
| Saka-mai | | | | |
| with de- | | | | |
| salted | | | | |
| surface | | | | |
| layer sea | | | | |
| water | | | | |
| Soaking and | 1,200 | 220 | 4,050 | 6,530 |
| Steaming | | | | |
| Saka-mai | | | | |
| with de- | | | | |
| salted | | | | |
| deep layer | | | | |
| sea water | | | | |
| Soaking and | 620 | 220 | 4,200 | 7,640 |
| Steaming | | | | |
| Indica rice | | | | |
| with tap | | | | |
| water | | | | |
| Soaking and | 815 | 220 | 4,200 | 7,710 |
| Steaming | | | | |
| Indica rice | | | | |
| with de- | | | | |
| salted | | | | |
| surface | | | | |
| layer sea | | | | |
| water | | | | |
| Soaking and | 895 | 225 | 4,210 | 7,830 |
| Steaming | | | | |
| Indica rice | | | | |
| with de- | | | | |
| salted deep | | | | |
| layer sea | | | | |
| water | | | | |
| | | | | (Unit/g Kooji) |

As is apparent from the results shown in Table 9, in both of Saka-mai and Indica rice, the enzymatic potency is stronger in the case of use of de-salted sea water. Particularly, good result is obtained in use of deep layer sea water.

Charging of Rice Vinegar

Rice vinegar from a refined sake is produced in the same manner as in the brewing of a refined sake. The ingredients of moromi is shown in Table 10.

TABLE 10

| | Syubo | Soe | Naka | Tome | |
|---|---|---|---|---|---|
| | Sake | First | Middle | Final | |
| | yeast | addition | addition | addition | Total |
| Total rice | 78 | 155 | 300 | 467 | 1,000 |
| Steamed | 58 | 100 | 240 | 347 | 755 |
| rice | | | | | |
| Kooji rice | 20 | 45 | 72 | 108 | 245 |
| Water | 86 | 140 | 374 | 650 | 1,250 |
| absorption | | | | | |
| (tap | | | | | |
| water) | | | | | |

Rice = Kg, Water absorption = 1

Materials is conducted in three stages, namely soe (first addition), naka (middle addition), tome (final addition) and 18 days after distillation, the product is separated Sake and Sake lees, and squeezed (Johsoh). The analysis results of Johsoh liquid are shown in Table 11.

TABLE 11

| | | | | Degree | Degree |
|---|---|---|---|---|---|
| | | | | of | of |
| | | | Degree of | amino | sake- |
| | Degree | Alcohol | acidity | acid | lees |
| | of sake | (%) | (ml) | (ml) | (%) |
| Soaking and | +0.5 | 19.1 | 3.07 | 1.83 | 22.6 |
| Steaming Saka- | | | | | |
| mai with tap | | | | | |
| water | | | | | |
| Soaking and | −0.5 | 19.3 | 3.13 | 1.79 | 22.0 |
| Steaming Saka- | | | | | |
| mai with de- | | | | | |
| salted surface | | | | | |
| layer sea water | | | | | |
| Soaking and | −1.5 | 20.0 | 3.38 | 1.72 | 20.4 |
| Steaming Saka- | | | | | |
| mai with de- | | | | | |
| salted deep | | | | | |
| layer sea water | | | | | |
| Soaking and | +1.3 | 18.1 | 2.80 | 2.30 | 29.3 |
| Steaming Indica | | | | | |
| rice with | | | | | |
| tap water | | | | | |
| Soaking and | +1.0 | 18.4 | 2.81 | 2.25 | 28.9 |
| Steaming Indica | | | | | |
| rice with | | | | | |
| de-salted | | | | | |
| surface layer | | | | | |
| sea water | | | | | |
| Soaking and | −0.4 | 18.8 | 2.85 | 2.10 | 26.2 |
| Steaming Indica | | | | | |
| rice with | | | | | |
| de-salted deep | | | | | |
| layer sea water | | | | | |

The results in Table 11 apparently show the following matters.

(1) In steamed rice treated with de-salted sea water, the dissolution of moromi proceeds, and after Johsoh, the percentage of sake-lees decreases, and the alcohol yield increases. Particularly, the alcohol yield in the case of deep layer sea water is large.

(2) When Indica rice is used and soaking in and steaming with in de-salted sea water, odor specific to Indica rice disappears. The degree of acidity is reduced and a peculiar taste decreases.

(3) Deep layer sea water provides more excellent results than surface layer sea water.

Brewing Preparation of Sake Vinegar

Sake brewed by the above-described process is adjusted (diluted) with tap water to an alcohol content of 12.8%, and used as a raw sake for sake vinegar charging. The blend ingredient is as follows: 350 liter of raw sake, 260 liter of seed vinegar and 500 liter of tap water, reaching a total amount of 1100 liter. As the raw sake, sake A and sake C are used as shown in Table 12 below.

TABLE 12

| | Sake A | Sake C |
|---|---|---|
| Raw material rice | Saka-mai | Saka-mai |
| Method of dealing | Soaking and Steaming | Soaking and Steaming |
| with raw material | with tap water | with de-salted Deep |
| | | layer sea water |
| Adjusting water, | Tap water | Tap water |
| Diluted water | | |
| Alcohol content | 12.8% | 12.8% |

Acetic acid fermentation is conducted at 30° C. according to a normal method, and when the degree of acidity reaches 5.0, the fermentation is terminated. The analysis results of the brewed sake vinegar are shown in Table 13.

TABLE 13

| | | Non- | | | | Amino- | | |
|---|---|---|---|---|---|---|---|---|
| | | volatil- | | Reduc- | | type | | |
| | Total | ized | | ing | Nitro- | nitro- | Ex- | |
| | acid | acid | Sugar | sugar | gen | gen | tract | pH |
| In case | 5.0 | 0.41 | 5.2 | 3.3 | 0.04 | 0.020 | 6.2 | 2.7 |
| of using | | | | | | | | |
| sake A | | | | | | | | |
| In case | 5.0 | 0.39 | 5.1 | 3.1 | 0.04 | 0.016 | 5.9 | 2.7 |
| of using | | | | | | | | |
| sake C | | | | | | | | |

(g/100 ml)

The results in Table 13 clearly show the following matters.

(1) In treatment with de-salted deep layer sea water, fermentation proceeds at the fastest rate, and fermentation flourishes.

(2) In treatment with de-salted deep layer sea water, the amount of amino-form nitrogen, by product of fermentation is smaller, and mild and fresh taste without peculiar taste is obtained.

(3) By replacing the raw material treating water by sea water, rice vinegar having excellent flavor is obtained.

(4) Fermentation is faster in the case of sake charging than in the case of alcohol charging.

(5) By replacing the charging water by sea water, brewed vinegar having excellent flavor is obtained.

Production of Fruit Vinegar

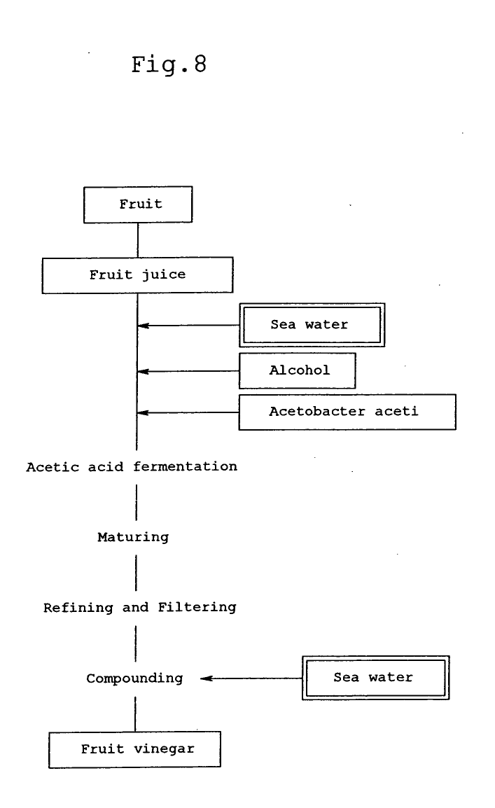

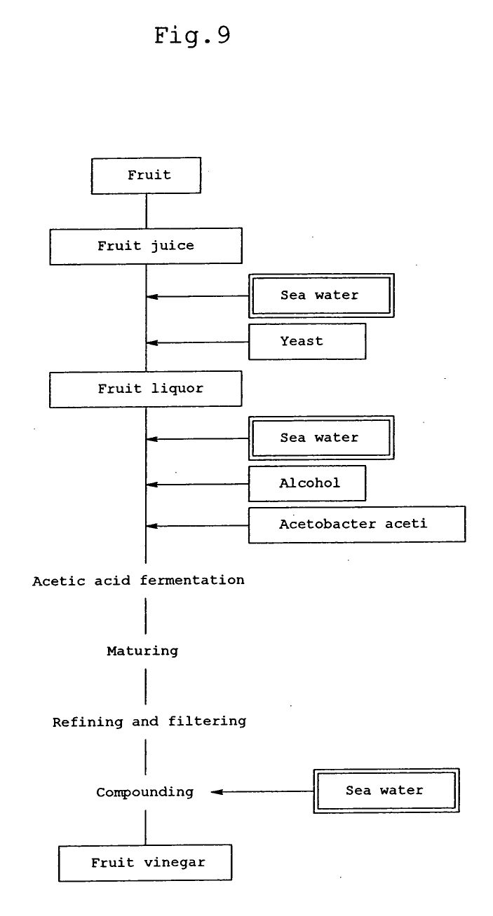

Also in the case of fruit vinegar, sea water is used. Examples of the process using sea water are as shown in flow charts of FIG. 8 and FIG. 9. An example of fruit vinegar produced via fruit wine is shown in FIG. 8.

Production of Rice Vinegar by Jar Fermentation Method

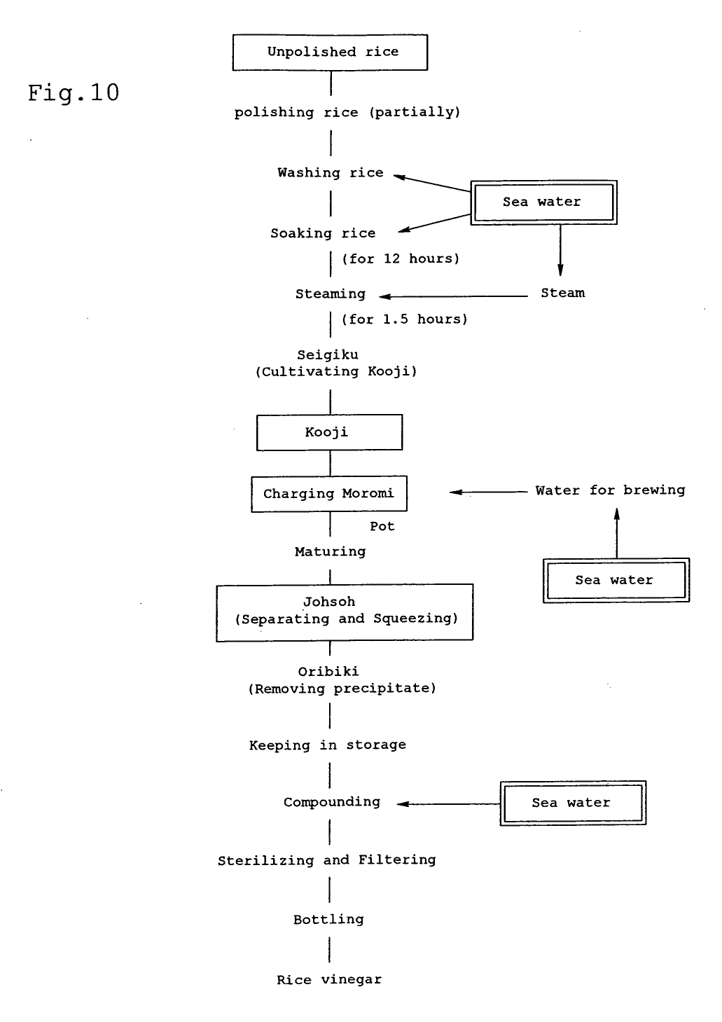

Also in producing rice vinegar by a jar fermentation method, sea water is used. An example of the process using sea water is as shown in a flow chart of FIG. 10.

### EXAMPLES 5 to 7

Production of Synthetic Vinegar

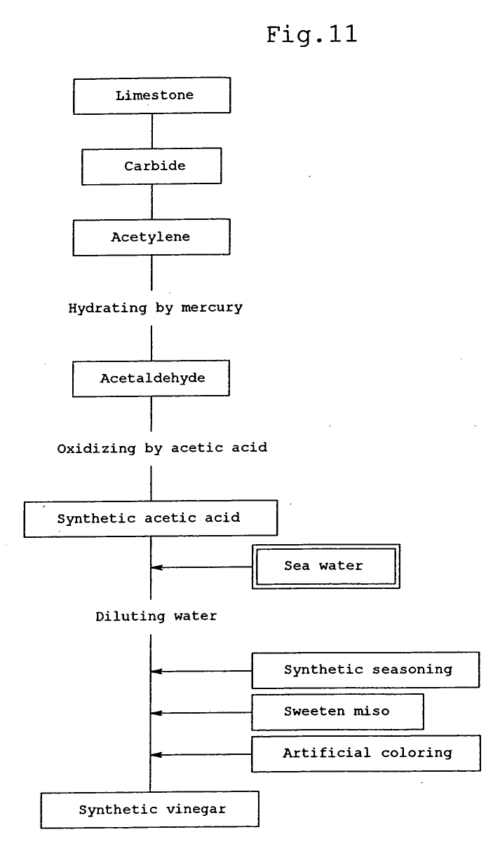

The production of synthetic vinegar is as shown in a flow chart of FIG. 11.

The diluting water is prepared as shown below.

(1) In the case of dilution with raw sea water (Example 5)

One liter of clean sea water containing no floating material is prepared.

(2) In the case of dilution with concentrated sea water (Example 6)

2 ml of concentrated sea water (salt content 4.2%) is diluted to 1 liter.

(3) In the case of dilution with de-salted sea water (Example 7)

One liter of de-salted sea water (salt content NaCl=0.00863%) is prepared.

(4) In the case of dilution with tap water (Comparative Example 2)

One liter of tap water left for 24 hours for deleting minerals is prepared.

Production Method

25 ml of glacial acetic acid obtained by synthesis, 2.5 g of a chemical seasoning (sodium glutamate) and 5 g of a sweetner (sugar) are added and diluted the above-mentioned dilution waters (1) to (4) to obtain a volume of 500 ml.

Thus obtained synthetic vinegar has a degree of acidity of 4.5%. In examples in which sea water, concentrated sea water and de-salted sea water are used as diluting water, a result is also obtained in which the evaporation of an acid is small as compared with the case using tap water in the comparative example, in the experiments of vinegar left in a room.

Production of Seasoning Liquid Using Vinegar

### EXAMPLE 8

Example of Awasezu (Blended Vinegar)

As the seasoning liquid using vinegar, 4 kinds of sushizu (awasezu=blended vinegar for sushi) shown in Table 14 below are prepared. As the water for compounding, tap water, surface layer sea water, deep layer sea water and concentrated deep layer sea water are used, and as the vinegar, vinegar having high acidity (degree of acidity 15%) is used.

TABLE 14

| | | | Blended | | | | Blended | |
|---|---|---|---|---|---|---|---|---|
| | | | vinegar | | Blended | | vinegar | |
| | Blended | | using | | vinegar | | using | |
| | vinegar | | surface | | using deep | | concentrated | |
| | using tap | | layer sea | | layer | | deep layer | |
| | water | | water | | sea water | | sea water | |
| Vinegar of high | 175 | ml | 126 | ml | 126 | ml | 126 | ml |
| acidity | | | | | | | | |
| Degree of | | | | | | | | |
| acidity = 15%) | | | | | | | | |
| Sugar | 550 | g | 550 | g | 550 | g | 550 | g |
| Salt | 118 | g | 103 | g | 103 | g | 87 | g |
| Glutamic acid | 7 | g | 7 | g | 7 | g | 7 | g |
| soda | | | | | | | | |
| Tap water | 443 | ml | — | | — | | — | |
| Surface layer | — | | 490 | ml | — | | — | |
| sea water *1 | | | | | | | | |
| Deep layer sea | — | | — | | 490 | ml | — | |
| water *2 | | | | | | | | |
| Concentrated | — | | — | | — | | 490 | ml |
| deep layer sea | | | | | | | | |
| water *3 | | | | | | | | |
| Total | 1,000 | ml | 1,000 | ml | 1,000 | ml | 1,000 | ml |

Each *1, *2, *3 are blended with vinegar of high acidity (Degree of acidity = 15%) beforehand. The blending ratio of the seawater and the vinegar is 9/1.

Sushi meshi (rice for sushi containing vinegar) are made by using these Awasezu (blended vinegar), and the water evaporation amount, degree of aging, hardness, number of fungus and functionality of the sushi meshi are examined.

(a) Preparation of Sushi Meshi

Rice is washed with water, water is allowed to drop, and water is added so that the amount of water is 350 g in total per 1 gou (140 g) of rice and soked for 90 minutes, then, boiled, and the above-mentioned Awasezu is mixed in an amount of 35 ml per 1 gou of rice to prepare Sushi meshi. Each of them is molded into Shari ball (small rice ball) (30 g), and stored in a plastic vessel wrapped with a film.

Result of Water Evaporation Amount Examination

For each sushi meshi, the water contents are measured after blending the vinegar and after storage at 5° C. for 24 hours, and the evaporation amount of water is calculated from the difference thereof. The water content is calculated from the reduction in weight after drying at 105° C. for 6 hours.

The result of water evaporation amount examination is shown in Table 15.

TABLE 15

| | 12 hours later | 24 hours later |
|---|---|---|
| Blended vinegar using tap water | 5.5 | 14.1 |
| Blended vinegar using | 3.2 | 6.2 |
| surface layer sea water | | |
| Blended vinegar using | 1.6 | 4.3 |
| deep layer sea water | | |
| Blended vinegar using concentrated | 1.2 | 3.2 |
| deep layer sea water | | |
| | | (%) |

As is apparent from Table 15, the evaporation of water is more difficult in the case of use of sea water than in the case of use of tap water for compounding blended vinegar, and particularly, the water evaporation of concentrated deep layer sea water is low. Therefore, drying of sushi delays. Moisture-retaining property is present, gloss is manifested, and the total eating feeling is improved.

(b) Aging Test

When sushi meshi is dried, fragile eating feeling occurs. Then, regarding 4 kinds of combined vinegar as produce above, the degree of aging is measured as a method for numerically representing aging. In this method, the degree of past forming of rice stored at 5° C. is measured (by β-amylase planase method (BAP method), and the change with the lapse of time is represented as the degree of aging.
Degree of aging %=100%·(degree of paste forming 24 hours after steaming/degree of paste forming directly after steaming)×100

Table 16 shows the results of measurement of the degree of aging.

TABLE 16

| | 12 hours later | 24 hours later |
|---|---|---|
| Blended vinegar using tap water | 3.5 | 7.9 |
| Blended vinegar using | 2.3 | 6.1 |
| surface layer sea water | | |
| Blended vinegar using | 1.9 | 4.5 |
| deep layer sea water | | |
| Blended vinegar using concentrated | 1.3 | 3.6 |
| deep layer sea water | | |
| | | (%) |

When sea water, particularly, concentrated deep layer sea water is used in blended vinegar, the degree of aging is low and preferable results are obtained.

(c) Hardness Test

The tendency of sushi meshi to harden in the case of storage at 5° C. is compared by measuring the hardness of 4 kinds of blended vinegar. The hardness is measured by using a rheometer. The results are shown in Table 17.

TABLE 17

| | Directly | 12 hours | 24 hours |
|---|---|---|---|
| | after | later | later |
| Blended vinegar using tap water | 93 | 117 | 122 |
| Blended vinegar using | 92 | 108 | 114 |
| surface layer sea water | | | |
| Blended vinegar using | 94 | 106 | 110 |
| deep layer sea water | | | |
| Blended vinegar using Concentrated | 94 | 103 | 106 |
| Deep layer sea water | | | |
| | | | (g/cm²) |

As is apparent also from this result, a shari ball (small rice ball containing vinegar) is soft when sea water is utilized. Particularly, in the case of concentrated deep layer sea water, and excellent result is obtained.

(d) Fungal Propagation Test

The tendency of fungus propagation in the case of storage at 30° C. is compared by measuring the number of propagated fungi for 4 kinds of blended vinegar. The results are shown in Table 18.

TABLE 18

| | Directly | 12 hours | 24 hours |
|---|---|---|---|
| | after | later | later |
| Blended vinegar using tap water | 21 × 10³ | 27 × 10⁴ | 13 × 10⁵ |
| Blended vinegar using | 25 × 10³ | 8 × 10⁴ | 37 × 10⁴ |
| surface layer sea water | | | |
| Blended vinegar using | 24 × 10³ | 57 × 10³ | 21 × 10⁴ |
| deep layer sea water | | | |
| Blended vinegar using concentrated | 22 × 10³ | 34 × 10³ | 6 × 10⁴ |
| deep layer sea water | | | |

From this result, it is known that the propagation of fungus of sushi meshi is suppressed by the use of sea water in blended vinegar. Particularly, in the case of concentrated deep layer sea water, the effect is large. This is hypothesized that not only the evaporation of water in Sushi meshi but also the evaporation of vinegar delay, and the vinegar remains in large amount in Sushi meshi, causing corrosion.

Each of the above-mentioned blended vinegar is charged in an amount of 150 ml into a cylindrical vessel having a diameter of 5.5 cm, and the volatilization degree of an acid is examined. The vessel is covered with a dense gauze so that dust and the like do not enter the vessel and left at room temperature at the same position.

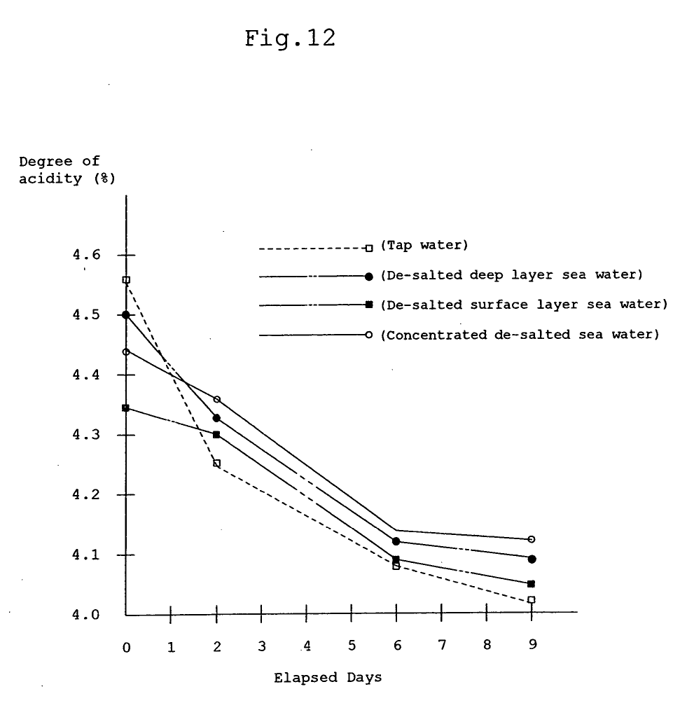

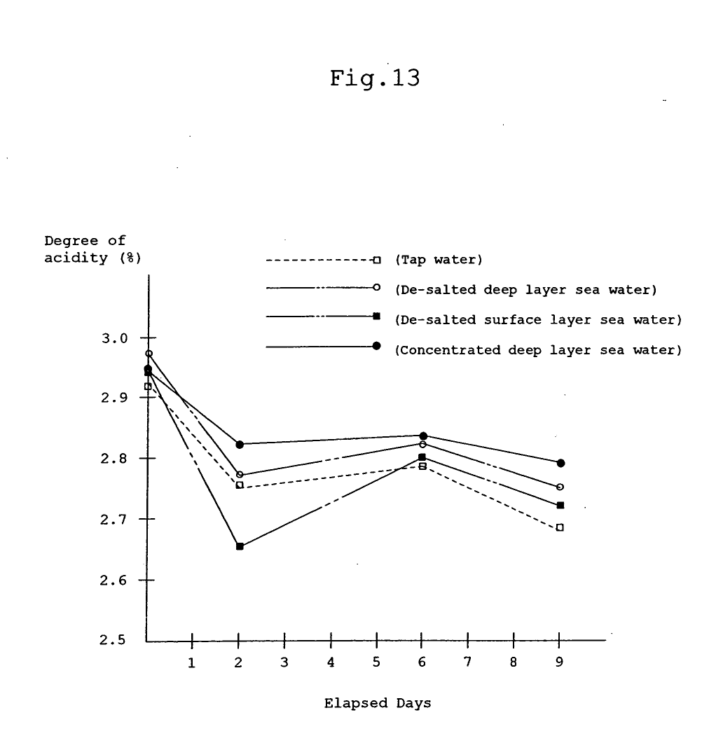

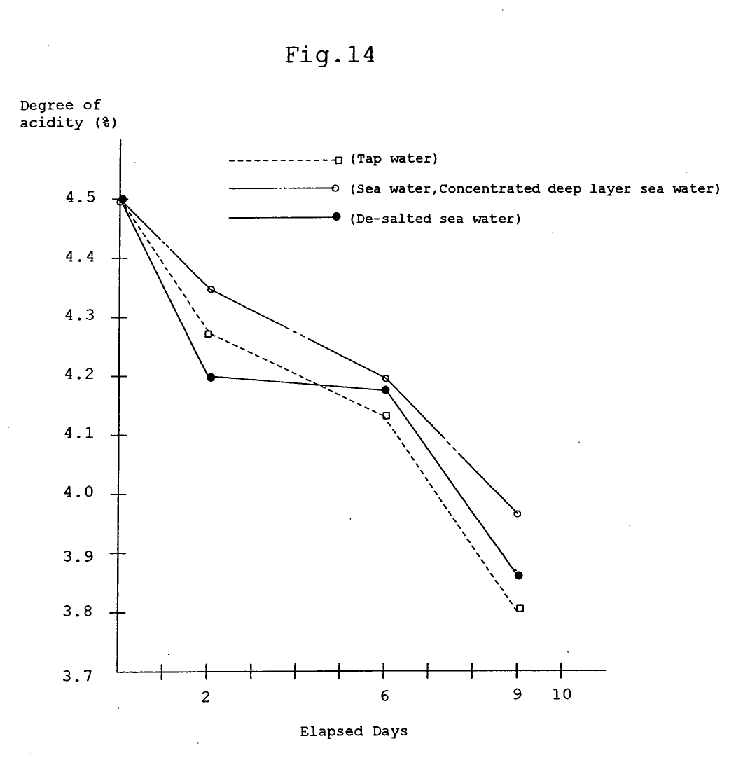

Sampling is continued from the vessel each in the same amount day by day, and the volatilization property of each acid is measured. FIG. 12 shows the case of vinegar having high degree of acidity (degree of acidity 15%) and FIG. 13 shows the case of organic pure rice vinegar (degree of acidity 10%). In any case, the volatilization tendency on an acid decreases in the order of tap water, deep and surface layer de-salted sea water and sea water. At 9th day of the experiment, apparent results are obtained. FIG. 14 shows the case of synthetic vinegar. The same tendency is observed as in the case of the brewed vinegar of the above-mentioned two example. However, the volatilization of an acid is totally faster than in the case of the brewed vinegar. Because of these facts, when sea water, concentrated sea water or de-salted sea water is used in blended vinegar, sour flavor remains for a log period of time, moisture-retaining property is obtained, and corrosion delays, in the case of use in Sushi. Further, acetic acid is not hardened, tackiness is kept, gloss is manifested, and total easing feeling is improve. Due to sterilizing ability of blended vinegar itself, general live fungi in sea water die. Then, useful sea water minerals can be collected in large amount in sterilized condition without any scientific treatment.

The features in the case of compounding of sea water and concentrated sea water in blended vinegar are listed below.

(1) When sushi meshi is cut (mixed with a shamoji (paddle so that rice is separated by the paddle), rice does not manifest stickiness and the gloss of each one grain is improved.

(2) Even when the rice is kept warm, generation of rice bran odor and brown coloration are sow, the reduction in flavor is extremely slow, and the rice does not easily become hard.

(3) When transported and transferred in the form of rice, it does not fixed or change into a block by vibration of a track, and the like.

(4) When frozen and thawed, the reduction in flavor is small (improvement in freezing-resistance).

(5) By the addition of sea water mineral, a mineral itself can be made up and simultaneously, strain of rice can be solved and an oxide can be neutralized.

(6) When sushizu (awasezu=blended vinegar) is used, stickiness does not occur and the water addition rte increases by 10 to 20%.

(7) Due to moisture-retaining property, it is not dried.

(8) Sour taste remains for a long period of time, and stored for a lot of days (freshness is maintained). Corrosion is slow.

### EXAMPLE 9

Example of Ajitsuke-ponzu (Seasoning Liquid that Blended Soy Sauce and Vinegar with Fruit Juice of Bitter Orange)

Vinegar produced by using sea water, concentrated sea water and de-salted sea water in examples, and tap water in comparative examples are used, and to them are added raw sea water, concentrated sea water and de-salted sea water (tap water as comparative example) instead of water necessary for preparing ajitsuke-ponzu, in addition to seasoning agents and fruit juice, and they are blended with ingredients as shown in Table 19.

TABLE 19

| | Vinegar | Vinegar | Vinegar | |
|---|---|---|---|---|
| | using de- | using | using | |
| | salted deep | surface | concentrated | Vinegar |
| | layer sea | layer sea | deep layer | using tap |
| | water | water | sea water | water |
| Mirin (sweet | 3.6 | 3.6 | 3.6 | 3.6 |
| sake used as | | | | |
| seasoning) | | | | |
| Brewed vinegar | 15 | 15 | 15 | 15 |
| Extract of | 2.0 | 2.0 | 2.0 | 2.0 |
| bonito | | | | |
| Extract of | 0.2 | 0.2 | 0.2 | 0.2 |
| tangle | | | | |
| Citron juice | 10 | 10 | 10 | 10 |
| Sugar | 10 | 10 | 10 | 10 |
| In case of | 19.2 | 19.2 | 19.2 | 19.2 |
| using | | | | |
| concentrated | | | | |
| deep layer sea | | | | |
| water | | | | |
| The amount of | 40 | 40 | 40 | 40 |
| added soy sauce | | | | |
| In case of | 19.2 | 19.2 | 19.2 | 19.2 |
| using | | | | |
| surface layer | | | | |
| sea water | | | | |
| The amount of | 40.927 | 40.927 | 40.927 | 40.927 |
| added soy sauce | | | | |
| In case of | 19.2 | 19.2 | 19.2 | 19.2 |
| using de-salted | | | | |
| deep layer sea | | | | |
| water | | | | |
| The amount of | 44.877 | 44.877 | 44.877 | 44.877 |
| added soy sauce | | | | |
| In case of | 19.2 | 19.2 | 19.2 | 19.2 |
| using tap water | | | | |
| The amount of | 44.887 | 44.887 | 44.887 | 44.887 |
| added soy sauce | | | | |

According to the ingredients as shown in Table 19, those obtained by using concentrated sea water, sea water and de-salted sea water manifest the following effects in the described order, as compared with the case using tap water.

(1) Flavors (of Yuzu (aromatic citron), Katsuo (bonito), Konbu (tangle) and the like) lasts for a long period. Particularly, citrus flavors last longer. (2) The vinegary taste lasts for a long period . (3) The taste of ajitshuke-ponzu becomes mild. (4) The humidity and freshness of food materials are maintained for a long period of time. (5) Flavors do not disappear from synthetic resin packs (including aluminum deposited film pack), PET vessels and the like.

### EXAMPLE 10

Example of Seasoning Vinegar for Processed Marine Products

Vinegar produced by using sea water, concentrated sea water and de-salted sea water in examples, and tap water in comparative examples are used, and to them are added sea water, concentrated sea water and de-salted sea water (tap water as comparative example) instead of water necessary for preparing seasoned vinegar for fishery processing, in addition to seasoning agents (sugar, salt, mirin (sweet sake for seasoning)), and they are blended with ingredients as shown in Table 20.

TABLE 20

| | Vinegar | Vinegar | Vinegar | |
|---|---|---|---|---|
| | using de- | using | using | |
| | salted deep | surface | concentrated | Vinegar |
| | layer sea | layer sea | deep layer | using tap |
| | water | water | sea water | water |
| Brewed vinegar | 60 | 60 | 60 | 60 |
| Sugar | 13 | 13 | 13 | 13 |
| Mirin | 2 | 2 | 2 | 2 |
| In case of | 21.5 | 21.5 | 21.5 | 21.5 |
| using | | | | |
| concentrated | | | | |
| deep layer sea | | | | |
| water | | | | |
| The amount of | 3.5 | 3.5 | 3.5 | 3.5 |
| added salt | | | | |
| In case of | 21.5 | 21.5 | 21.5 | 21.5 |
| using | | | | |
| surface layer | | | | |
| sea water | | | | |
| The amount of | 3.7 | 3.7 | 3.7 | 3.7 |
| added salt | | | | |
| In case of | 21.5 | 21.5 | 21.5 | 21.5 |
| using de-salted | | | | |
| deep layer sea | | | | |
| water | | | | |
| The amount of | 4.4 | 4.4 | 4.4 | 4.4 |
| added salt | | | | |
| In case of | 21.5 | 21.5 | 21.5 | 21.5 |
| using tap water | | | | |
| The amount of | 4.4 | 4.4 | 4.4 | 4.4 |
| added salt | | | | |

This seasoning vinegar for processed marine products can be used in vinegar pickles of Aji (horse mackerel), Shimesaba (mackerel with vinegar and salt), vinegar pickles of Tai (sea bream) and Tako (octopus), vinegar pickles of Mamakari (Sappa=kind of sardine) and the like, and those obtained by using concentrated deep layer sea water, surface layer sea water and de-salted deep layer sea water manifest effects as shown below in the described order, as compared with the case using tap water.

(1) Fish odor disappears and the stiffness of a body and the duration of color are improved. (2) Freshness is kept for a long period. (3) The propagation of fungi is low. (4) The taste becomes mild (both in seasoning vinegar and fish flesh).

### EXAMPLE 11

Example of Tare of Tataki (Relish Paste for Lightly Roasted Bonite or Beef)

Vinegar produced by using surface layer sea water, concentrated deep layer sea water and de-salted deep layer sea water in examples, and tap water in comparative examples are used, and to them are added surface layer sea water, concentrated deep layer sea water and de-salted deep layer sea water (tap water as comparative example) instead of water necessary for preparing relish paste for Tataki, in addition to seasoning agents (soy sauce, soy sauce-mixed vinegar, Katsuo extract, Konbu extract), flavoring agents (Yuzu fruit juice) and the like, and they are blended with ingredients as shown in Table 21.

TABLE 21

| | Vinegar | Vinegar | Vinegar | |
|---|---|---|---|---|
| | using de- | using | using | |
| | salted deep | surface | concentrated | Vinegar |
| | layer sea | layer sea | deep layer | using tap |
| | water | water | sea water | water |
| Brewed vinegar | 30 | 30 | 30 | 30 |
| Citron juice | 5 | 5 | 5 | 5 |
| Mirin | 4 | 4 | 4 | 4 |
| Extract of | 5 | 5 | 5 | 5 |
| bonito | | | | |
| Extract of | 1 | 1 | 1 | 1 |
| tangle | | | | |
| In case of | 20 | 20 | 20 | 20 |
| using | | | | |
| concentrated | | | | |
| deep layer sea | | | | |
| water | | | | |
| The amount of | 35 | 35 | 35 | 35 |
| added soy sauce | | | | |
| In case of | 20 | 20 | 20 | 20 |
| using | | | | |
| surface layer | | | | |
| sea water | | | | |
| The amount of | 36 | 36 | 36 | 36 |
| added soy sauce | | | | |
| In case of | 20 | 20 | 20 | 20 |
| using de-salted | | | | |
| deep layer sea | | | | |
| water | | | | |
| The amount of | 40.2 | 40.2 | 40.2 | 40.2 |
| added soy sauce | | | | |
| In case of | 20 | 20 | 20 | 20 |
| using tap water | | | | |
| The amount of | 40.1 | 40.1 | 40.1 | 40.1 |
| added soy sauce | | | | |

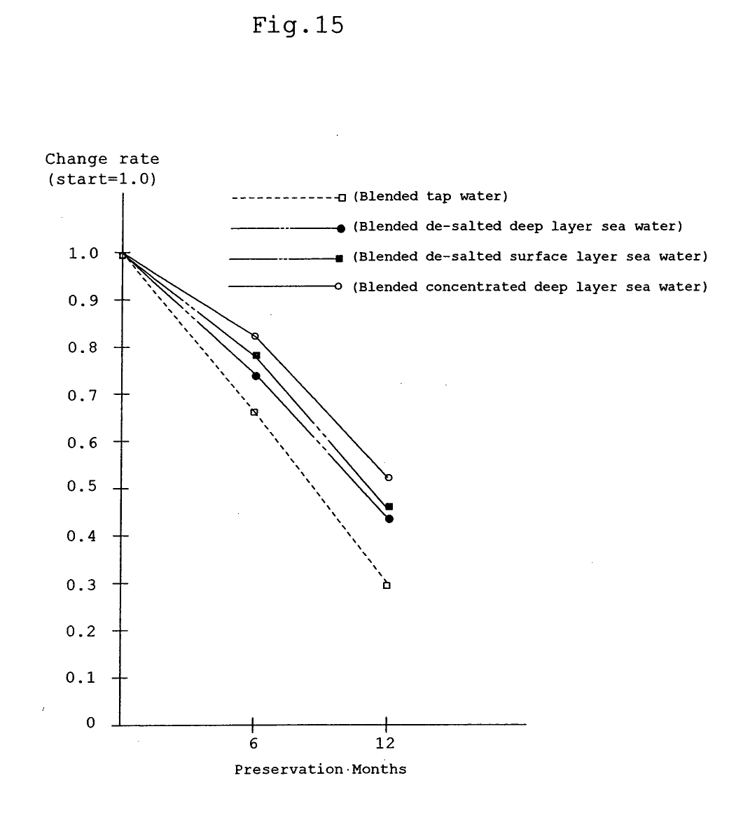

This tare (relish paste) of Tataki (lightly roasted bonito or beef) is used for Tataki of Katsuo, beef and the like. FIG. 15 shows, in a graph, that the decreasing tendency of vinegar in the case where the tare of Tataki is packed in LDPE/AL/LDPE polyester packs and stored. Those obtained by using concentrated deep layer sea water, surface layer sea water and de-salted deep layer sea water manifest effects as shown below in the described order, as compared with the case using tap water.

(1) Flavor and freshness of Yuzu, Katsuo, Konbu and the like last for a long period of time. Particularly, citrus flavor lasts longer. (2) Sour flavor lasts for a long period of time. (3) The taste of Tare of Tataki and food stuff become mild. (4) Flavors do not disappear from synthetic resin packs (including aluminum deposited film pack), PET vessels and the like.

According to the present invention, the brewing process of vinegar can be shortened, taste is improved, and flavor becomes excellent. Further, in seasoning liquid using vinegar, taste, flavor, moisture-retaining property, storability and the like can be improved. Further, due to sterilizing potency of seasoning liquid itself, process for scientifically sterilizing sea water is not necessary, and raw sea water itself and useful mineral components thereof can be utilized without any loss.

1-14. (canceled).

15. Seasoning liquid prepared by mixing vinegar, and any one of sea water, concentrated sea water, de-salted sea water, and one or more of a salty agent, a sweetener, a sour agent, a bitter agent a tasting agent and an oil agent.

16. Seasoning liquid according to claim 15 wherein the prepared product by mixing is any one of Awasezu (blended vinegar), Ajitsuke-ponzu (seasoning liquid that blended soy sauce and vinegar with fruit juice of bitter orange), Tare of Tataki (relish paste for lightly roasted bonito or beef), and seasoning vinegar for processed marine products.
